(19) United States
(12) Patent Application Publication
(10) Pub. No.: US 2026/0273683 A1
(43) Pub. Date: Sep. 17, 2026

(54) Device and method for machining workpieces on a multi-spindle lathe

(71) Applicant: HG Medical GmbH, Raisting (DE)

(72) Inventor: Sebastian SCHMID, Dießen/Dettenschwang (DE)

(21) Appl. No.: 19/164,013

(22) PCT Filed: Mar. 12, 2024
(86) PCT No.: PCT/EP2024/056570

§ 371 Date: Sep. 10, 2025

(30) Foreign Application Priority Data
Mar. 15, 2023 (EP) 23161971.9

(51) Int. Cl. B23Q 39/04; B23G 1/32; B23Q 39/00

(52) U.S. Cl. CPC B23Q 39/044; B23G 1/32; B23G 2240/60; B23Q 2039/008

(57) ABSTRACT

The invention relates to a device for machining workpieces (7) on a multi-spindle lathe (1), wherein the device comprises at least one tool carrier (4) with a tool slide (5) and at least two tool slides (5, 5′, 5″) are assigned to a rotatably mounted workpiece spindle (3) of the multi-spindle lathe (1), wherein workpieces (7) to be machined are disposed in the workpiece spindles (3), wherein at least one whirling-turning-milling unit (8) is disposed on a first tool slide (5, 5′) and at least one guide bush carrier (12) with at least one guide bush (13) is disposed on the second tool slide (5, 5″), and the guide bush carrier (12) guides the workpiece (7) during the machining by means of the whirling-turning-milling unit (8).

The invention relates to a device and method for machining workpieces, as well as a tool carrier and a multi-spindle lathe according to the preambles of claims 1, 8, 10, and 12.

A lathe is a machine tool used in the machining of workpieces. Lathes are classified according to the type of machine bed, the position of the spindle, or the number of spindles. As a rule, the workpiece performs a rotary movement, wherein the turning processes differ depending on the type of surface to be produced (round turning, face turning, thread turning, grooving, profile turning, form turning).

For the production of simple parts in large quantities, such as nuts or screws, automatic lathes (single-spindle or multi-spindle automatic lathes) are used, which have one or more controlled slides and/or turrets equipped with tools. In a multi-spindle automatic lathe, the workpiece spindles are rotated in cycles to individual machining stations, where the workpiece is machined step by step. A substantial advantage of a multi-spindle automatic lathe is that it allows several production steps to be carried out in parallel.

The company INDEX-Werke GmbH & Co. KG Hahn & Tessky, for example, offers the MS22-8, a CNC multi-spindle automatic lathe with eight rotary driven workpiece spindles, two swiveling synchronous spindles, and up to 16 tool carriers that can be configured in the X, Y, and Z directions. The workpiece spindles can hold workpieces with a maximum bar diameter of 22 mm. On the tool carrier, standing and rotary driven tools can be arranged, which enable, for example, off-center drilling and thread cutting, drilling (angle and cross drilling), contour milling, or polygon turning.

Automatic lathes are divided into short-turning automatic lathes (short-turning machines) and long-turning automatic lathes (long-turning machines). With a short-turning tool, the workpiece cannot be moved axially relative to the tools. Here, the tool performs the axial movement. In contrast, with a long-turning lathe, there is relative movement between the workpiece and the tool, wherein the workpiece is pushed into the respective spindle by a loading system, clamped by a collet chuck, and guided in a guide bush (bezel).

Until now, short-turning automatic lathes could only be used to machine workpieces with a relatively short length in relation to their diameter. Short-cycle automatic lathes and multi-spindle automatic lathes were previously unsuitable for long and narrow turned parts because the unfavorable length-to-diameter ratio prevented stable or precise machining, particularly in the area of the workpiece tip.

Various high-speed lathes, long lathes, and multi-spindle lathes are already known from the prior art.

DE 10 2017 121 295 A1 discloses a multi-spindle lathe with a rotatably mounted spindle drum with workpiece spindles, wherein the workpieces can be positioned relative to stationary spindle stations by rotating the spindle drum. For machining longer workpieces, in the present embodiment, each workpiece spindle is assigned a workpiece guide bush for guiding a material bar held in the workpiece spindle, which is arranged so as to be movable relative to the respective workpiece spindle in a direction parallel to the workpiece spindle axis.

EP 3 208 016 A2 discloses a tool holder for a long-turning lathe, wherein a housing with a rotary driven shaft is arranged on a tool slide, which drives different tools, such as a thread whirling device or a milling device, via driver elements. However, this embodiment is only suitable for a long-turning lathe and not for a multi-spindle automatic lathe.

The disadvantage of conventional multi-spindle lathes is that long workpieces with a length three times their diameter cannot be machined without the workpiece oscillating or vibrating during machining.

Another disadvantage of conventional multi-spindle lathes arises when machining long workpieces, for example when manufacturing a screw, which requires at least three machining steps (turning, milling, whirling). Since not every slide on the multi-spindle lathe has a Y axis, it is not possible to perform deburring and turning at the same spindle station. Machining with a turning tool must therefore be carried out on another slide, which means that the multi-spindle lathe is not used to its full potential.

The present invention therefore has the object of further developing a tool carrier or tool for a tool slide on a multi-spindle lathe so that long workpieces can be machined while at the same time making optimum use of the multi-spindle lathe.

For achieving the object of the invention, the invention is characterized by the technical teachings of claims 1, 8, 10, and 12.

A substantial feature of the invention is that at least one whirling-turning-milling unit is arranged on a first tool slide and at least one guide bush carrier with at least one guide bush is arranged on the second tool slide, and that the guide bush carrier guides the workpiece during machining with the whirling-turning-milling unit.

The embodiment according to the invention has the advantage that long workpieces can now also be machined with a multi-spindle lathe, since the workpiece is guided and stabilized by the guide bush carrier and the associated guide bush during the machining process.

The guide bush carrier is preferably arranged on the adjacent slide of the whirling-turning-milling unit and holds or guides the workpiece to be machined between the workpiece spindle and the tool. This ensures that the workpiece is guided or held in the space between the workpiece spindle and the tool. The guide bush carrier is therefore an additional component which guides and stabilizes the workpiece during machining by means of an adjacent tool slide.

In a first preferred embodiment, the multi-spindle lathe has a plurality of tool carriers with movable tool slides. Two tool carriers are assigned to each workpiece spindle and form a spindle position. This means that two tool slides are assigned to each spindle station. Preferably, the first tool slide and the second tool slide are arranged in a V-shape, wherein the intersection point is oriented toward the center of the workpiece spindle. The whirling-turning-milling unit is arranged on the first slide and the guide bush carrier with the guide bush is arranged on the second slide.

The terms “first tool slide” and “second tool slide” are used only as examples. These are two adjacent tool slides. These tool slides can be in any spindle position. In the embodiment according to the invention, any tool slides can be used. Some tools do not require movement in the Y axis, meaning that standardized tool slides can also be used.

The whirling-turning-milling unit according to the invention preferably comprises a housing which is arranged on a tool slide. The housing is U-shaped and has two protruding legs. A first tool is arranged on the first leg, which is designed, for example, as a swivel unit. A second tool is arranged on the second leg, which is designed, for example, as a milling unit. In addition, a turning unit is arranged on the second leg.

The whirling-turning-milling unit thus combines three different tools in one housing and on one tool slide. The shape of the whirling-turning-milling unit is designed so that there are no collisions between the individual tools. The tool can be designed as a rotary driven or non-rotary driven tool, such as a swivel unit, a turning unit, or a milling unit.

The whirling-turning-milling unit is preferably arranged on a tool slide of the multi-spindle lathe, which performs movement in the X, Y, and Z axes. The 3 axis movement makes it possible to position the individual tools of the whirling-turning-milling unit precisely opposite the workpiece, which is arranged in one of the workpiece spindles during machining.

In a preferred embodiment, a first driven tool is located on the first leg and a second driven tool is located on the second leg of the housing of the whirling-turning-milling unit. The tools are driven by a transmission device and a drive motor, which is arranged in the base of the tool slide, for example.

In a further preferred embodiment, the drive motor is flanged directly to the whirling-turning-milling unit and is controlled by the multi-spindle lathe.

The transmission device is used to transfer forces of all kinds. The transmission device is designed, for example, as a gear drive, toothed belt drive, chain drive and/or belt drive.

The housing of the whirling-turning-milling unit has a first leg, an intermediate web-like connecting body and a second leg, wherein all components have recesses and bores to accommodate the transmission devices. The individual tools are coupled to the transmission device, wherein power is transmitted between the first and second legs preferably via a rotatable shaft, which is arranged in the connecting body.

The guide bush carrier according to the invention comprises a carrier body with a recess for accommodating a guide bush. A guide bush is a type of bearing that guides the workpiece. Preferably, the guide bush is designed as a hollow cylinder made of a special material with a defined inner and outer diameter. The guide bush is a linear plain bearing, for example, which provides the workpiece with a type of sliding guide.

In a further preferred embodiment, the guide bush is upright, driven by the workpiece spindle or has its own motor which actively drives the bush during machining.

Preferably, the guide sleeve is interchangeable, wherein the diameter of the sleeve corresponds approximately to the diameter of the workpiece to be machined.

In a preferred embodiment, the guide bush carrier has an external pressure supply (pump or gas pressure vessel) which continuously presses a liquid lubricant into the guide bush at a constant pressure via inlet channels, creating a thin film of lubricant between the guide bush and the workpiece.

The multi-spindle lathe comprises a machine frame on which a spindle drum is arranged so as to be rotatably driven about a spindle drum axis. Preferably, the spindle drum has eight rotatably driven workpiece spindles, which are evenly distributed around the circumference of the spindle drum. The workpiece to be machined is held in the workpiece spindle by a collet chuck. By turning the spindle drum, the workpiece spindles are rotated in relation to the assigned tool carriers. The tool carriers are arranged stationary on the machine frame. On the tool carriers, there are tool slides with tools that can be moved in relation to the workpieces. The tool carriers with the tool slides are preferably arranged in pairs, wherein two tool carriers, i.e. a pair of slides, are assigned to each tool spindle. A spindle position thus comprises a tool spindle and a pair of slides, which are arranged in a V-shape. With eight tool spindles, there are therefore eight spindle positions with 16 slides.

The tool slide is moved by means of a slide drive. The drive motor is preferably located in the tool carrier base and drives a spindle drive, for example. With the tool slide, the held tool can be moved both in the X direction transverse to the respective axis of the workpiece spindle and in the Z direction parallel to the respective axis of the workpiece spindle. Optionally, some slides can be moved in the Y axis.

In a preferred embodiment, the multi-spindle lathe has at least one swiveling synchronous spindle, which is used to machine the rear side of the workpiece.

In a further preferred embodiment, the multi-spindle lathe has at least two whirling-turning-milling units which are arranged in two spindle positions. The two spindle positions are synchronized in such a manner that there is no collision between the two adjacent whirling-turning-milling units.

The present patent application also claims a method for machining a workpiece. In the method, a multi-spindle lathe is preferably used, which has at least one tool spindle and at least two slides arranged in a V-shape opposite the tool spindle, wherein a swivel-rotary milling unit is arranged on the at least one slide and a guide bush carrier is arranged on the other slide, wherein the following method steps are carried out:
1. arranging at least one workpiece in the workpiece spindle of the multi-spindle lathe;
2. positioning the guide bush carrier relative to the workpiece, wherein a guide bush of the guide bush carrier is placed on the workpiece to be machined so that the workpiece is guided by the guide bush in the intermediate area between the tool spindle and the tool;
3. aligning the whirling-turning-milling unit, which comprises a whirling unit, a milling unit and a turning unit, and then machining the workpiece with the whirling unit and/or milling unit and/or turning unit.

In a preferred embodiment, the method according to the invention is used to produce a screw with a multi-spindle lathe. The multi-spindle lathe has at least one tool spindle and at least two tool carriers with tool slides, which are arranged in a V-shape opposite the tool spindle, wherein a whirling-turning-milling unit is arranged on the at least one tool slide and a guide bush carrier is arranged on the other tool slide, wherein the following process steps are carried out:
1. arranging at least one workpiece in the workpiece spindle of the multi-spindle lathe;
2. positioning the guide bush carrier relative to the workpiece, wherein a guide bush of the guide bush carrier is placed on the workpiece to be machined in the Z axis, so that the workpiece is guided by the guide bush between the tool spindle and the tool.
3. rotating the tip
   Aligning the whirling-turning-milling unit, wherein a turning unit is aligned with the workpiece in the X, Y and Z axes and then machining the workpiece with the turning unit;
4. milling cutting
   Aligning the whirling-turning-milling unit, wherein a milling unit is aligned relative to the workpiece in the X, Y, and Z axes, and subsequently machining the workpiece with the milling unit;
5. whirling threads
   Aligning of the whirling-turning-milling unit, wherein a whirling unit is oriented relative to the workpiece in the X, Y, and Z axes, and subsequent machining of the workpiece with the whirling unit;

The methods described are only examples. The individual method steps and operations can be repeated as often as required and the sequence can be interchanged.

The subject matter of the present invention does not only result from the subject matter of the individual claims, but also from the combination of the individual claims with one another.

All information and features disclosed in the documents, including the summary, in particular the spatial design shown in the drawings, are claimed to be essential to the invention.

In the following, the invention is explained in more detail with the aid of drawings illustrating several embodiments. The drawings and their description show further features and advantages of the invention which are essential to the invention.

In the figures:

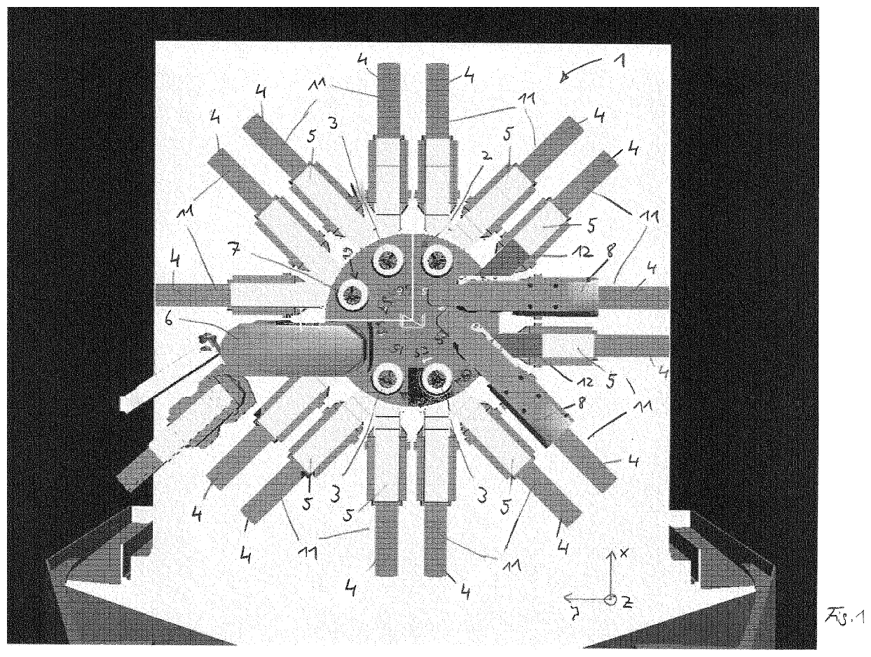

FIG. 1: is a schematic representation of a multi-spindle lathe with eight spindle stations

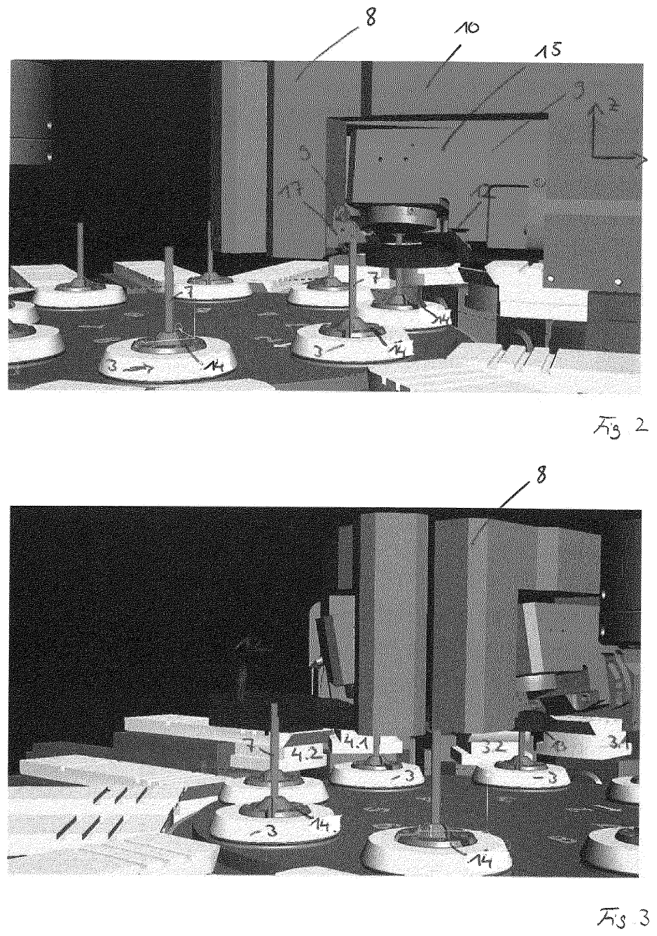

FIG. 2: is a schematic representation of the whirling-turning-milling unit and the guide bush carrier

FIG. 3: is a schematic representation of two whirling-turning-milling units and two guide bush carriers

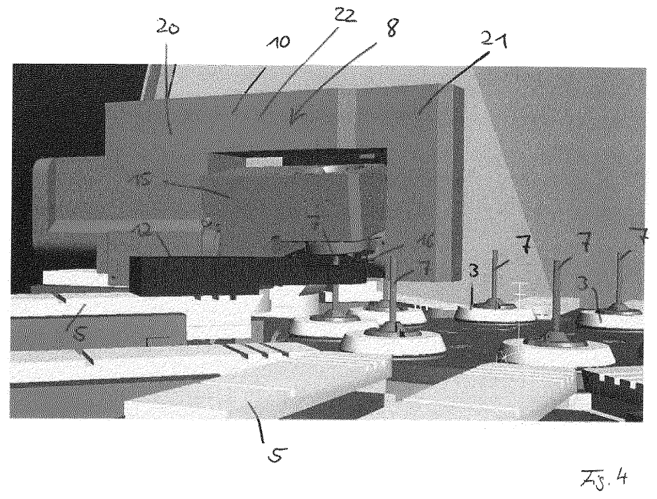

FIG. 4: is a schematic side view of the whirling-turning-milling unit and the guide bush carrier

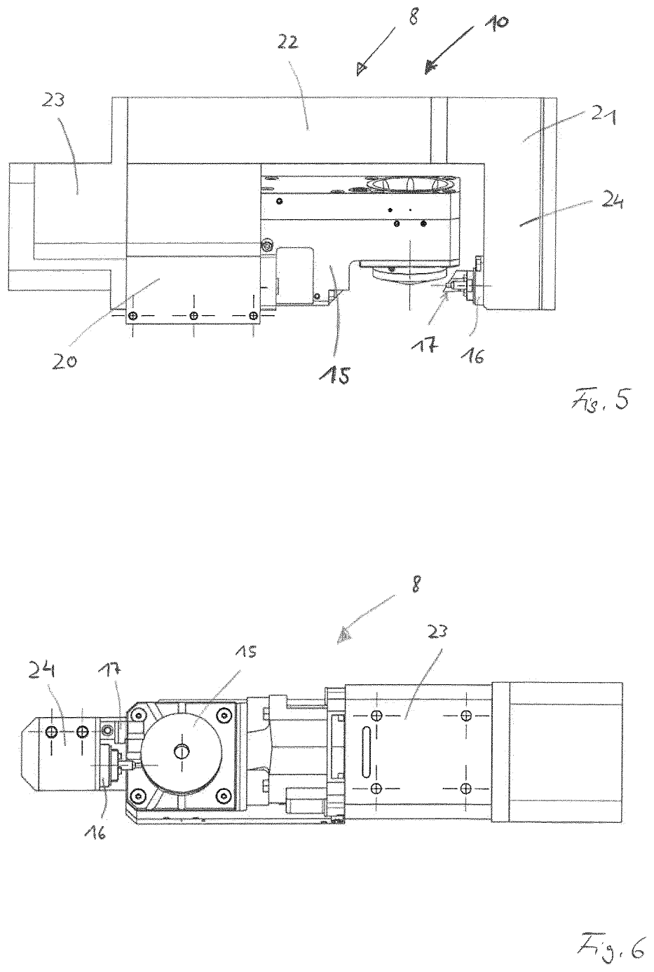

FIG. 5: is a side view of the whirling-turning-milling unit

FIG. 6: is a bottom view of the whirling-turning-milling unit

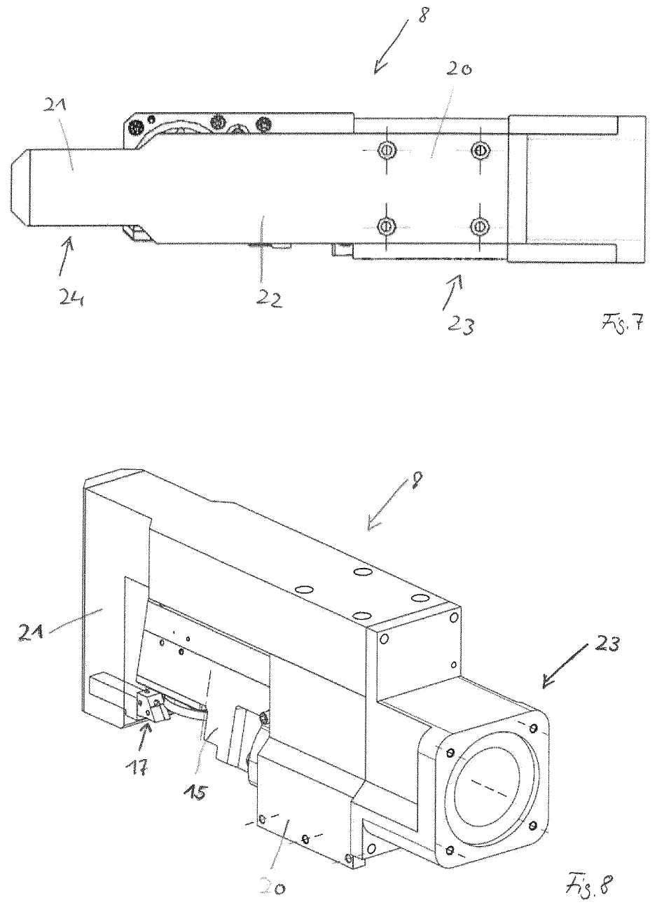

FIG. 7: is a top view of the whirling-turning-milling unit

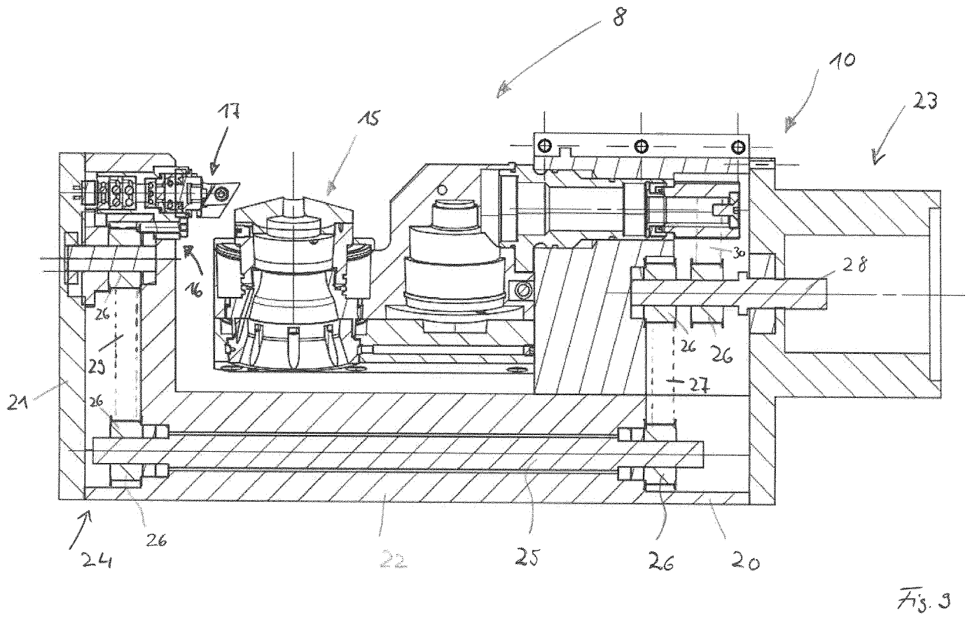

FIG. 8: is a perspective view of the whirling-turning-milling unit

FIG. 9: is a sectional view of the whirling-turning-milling unit

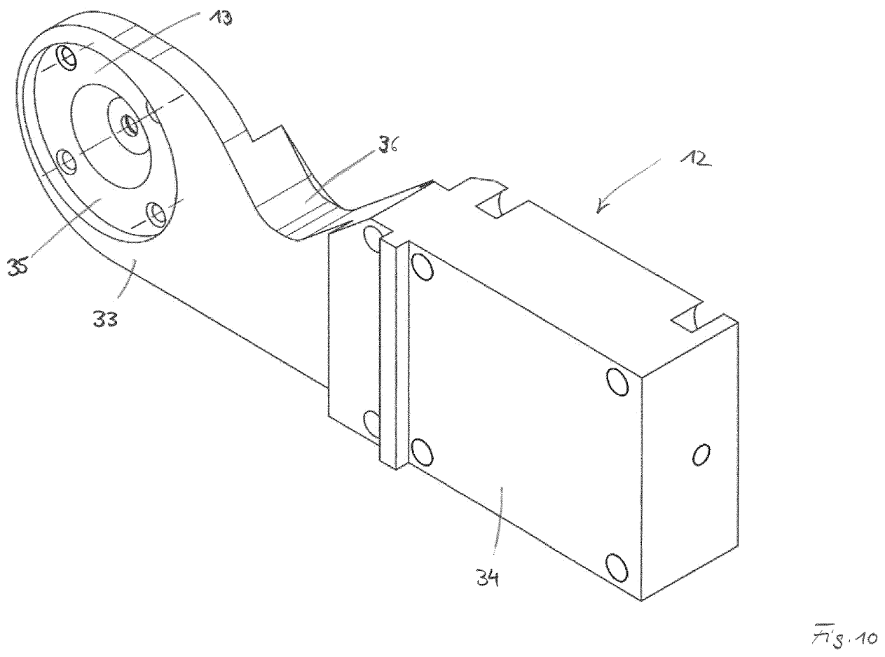

FIG. 10: is a perspective view of the guide bush carrier

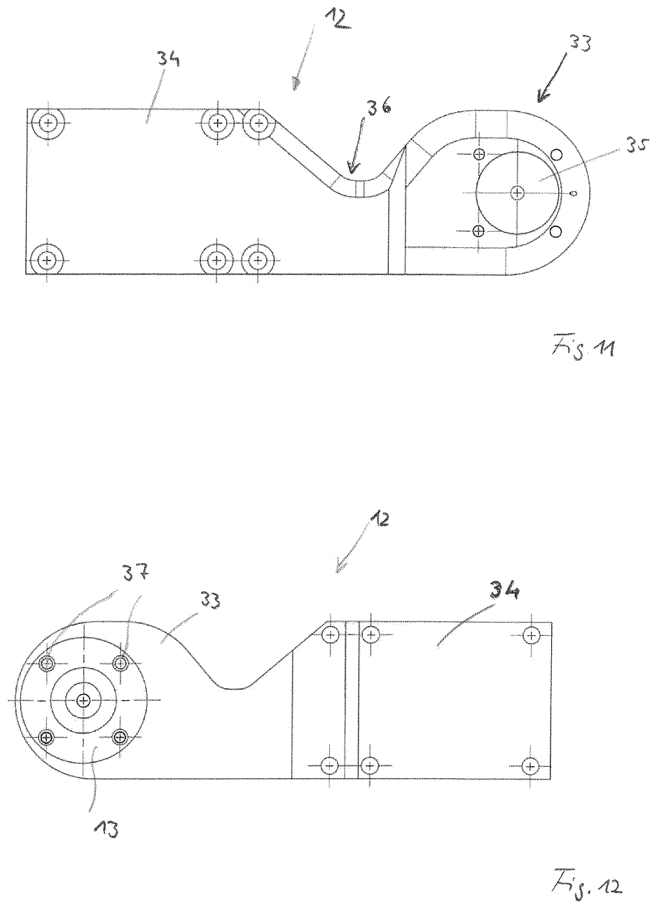

FIG. 11: is a top view of the guide bush carrier

FIG. 12: is a bottom view of the guide bush carrier

FIG. 1 shows a machine tool designed as a multi-spindle lathe 1. The multi-spindle lathe 1 has a machine bed with a rotatably mounted spindle drum 2 and workpiece spindles 3 that are driven in rotation relative to the spindle drum 2. The workpieces 3 to be machined are arranged in the workpiece spindles 3. To machine the workpieces 7, the spindle drum 2 is rotated to the individual spindle positions and machined there with various tools 9, which are arranged on tool slides 5.

The multi-spindle lathe 1 has eight rotary driven workpiece spindles 3, wherein each workpiece spindle 3 is assigned two tool slides 5. The pairs of slides 11 (slide units) are each arranged in a V-shape to the center of the respective tool spindle 3 and form a so-called spindle station 19. In the present embodiment, there are thus a total of eight spindle stations 19, each of which is identified by a number.

According to FIG. 1, a synchronous spindle 6 (=tapping spindle) is arranged on the eighth spindle station (No. 8), which is designed as a swivel synchronous spindle. After machining, the synchronous spindle 6 takes the workpiece 7 from the workpiece spindle 3. The arrangement of a synchronous spindle 6 eliminates the need for a tool slide 5 at the spindle station 19. The other tool slide 5 of the eighth spindle station 19 is used to set up the synchronous spindle 6.

Each tool slide 5 can be moved in the Z axis, whereby the slide 5 is spaced from the spindle drum 2 with a stroke of 100 mm, for example. Furthermore, each tool slide 5 can be moved in the X axis, allowing the tool slide 5 to be moved relative to the workpiece spindle 3. A movement in the X axis is necessary to move the innovative swivel-rotary milling unit 8, which is arranged on the tool slide 5. The movement in the X axis brings the various tools 9 of the whirling-turning-milling unit 8 into engagement with the clamped workpiece 7 in the workpiece spindle 3.

The tool slides 5 on the spindle stations 3.1, 4.1, 5.1 and 6.1 preferably have a Y axis drive, which allows the whirling-turning-milling unit 8 to swivel in height. This is always useful when several tools 9 need to be corrected in the Y direction or when machining requires a Y axis.

Preferably, both tool slides 5 of a slide pair 11 are used for machining on a workpiece spindle 3. According to FIG. 1, a guide bush carrier 12 is arranged on a tool slide 5 in each of the positions 3.2 and 4.2. The guide bush carrier 12 accommodates a separate guide bush 13, wherein the guide bush 13 is adapted to the diameter of the workpiece 7 to be machined. For example, the guide bush 13 is suitable for holding a 5 mm workpiece. The guide bush 13 is supplied with a coolant, whereby hydrostatic guidance of the workpiece 7 within the guide bush 13 is achieved.

Each slide 5 can be controlled independently. This has the advantage that the guide bush 13 can hold or guide the workpiece 7 at different points. For example, when the whirling-turning-milling unit 8 moves in the Z direction, the guide bush carrier 12 also moves in the Z direction simultaneously or in parallel and at a predefined distance. This ensures that the workpiece 7 is sufficiently guided by the guide bush 13 at all times, wherein the whirling-turning-milling unit 8 and the guide bush carrier 12 do not collide with each other.

Furthermore, the shape of the guide bush carrier 12 is adapted to the shape of the collet chuck 14 of the workpiece spindle 3. Preferably, the guide bush carrier 12 can be moved downwards in the Z direction until the guide bush 13 is almost at the same height as the collet chuck 14.

According to FIG. 1, the whirling-turning-milling unit 8 is arranged on the slide 3.1 and the guide bush carrier 12 is arranged on the slide 3.2. Preferably, the guide bush carrier 12 is moved in the Z axis during machining of the workpiece 7.

The swivel plate seat, i.e. the plate seat for the swivel blades, corresponds to the swivel axis of the whirling unit 15. This makes it possible to adjust the whirling unit 15 according to the angle of the pitch of the desired thread of the screw. The whirling-turning-milling unit 8 is arranged on a tool slide 5, which can be moved in the Y axis. This allows an offset of the whirling blades to be compensated if the center of the swivel does not correspond to the center of the cutting edge.

FIG. 2 shows the machining of a workpiece 7 using the whirling-turning-milling unit 8 and the guide bush carrier 12. The whirling-turning-milling unit 8 comprises a housing 9 on which various tools 9 are arranged. The tools 9 are a whirling unit 15, a milling unit 16 and a turning unit 17.

One end of the workpiece 7 is clamped in the collet chuck 14 of the workpiece spindle 3. The other end of the workpiece 7 is machined with the whirling unit 15, wherein the whirling unit 15 is moved in the Z axis. At the same time or in parallel, a controlled movement of the guide bush carrier 12 takes place so that sufficient guidance of the workpiece 7 is always achieved. The guide bush 13 is thus always located at a distance (e.g. 1 to 2 mm) below the whirling unit 15 and is moved in the Z axis during machining with the tool 9, such that the workpiece 7 is sufficiently guided relatively close to the machining area. This results in parallel movement of the guide bush carrier 12 during machining of the workpiece 7 with the tool 9 of the whirling-turning-milling unit 8.

By the controlled guidance of the guide bush carrier 13, the workpiece 7 is stabilized during machining. This means that relatively long workpieces 7 can be machined, as the guide bush carrier 13 guides the workpiece 7 between the collet chuck 14 of the workpiece spindle 3 and the respective tool 9 in the manner of a plain bearing.

FIG. 3 shows another view of the whirling-turning-milling unit 8 and the guide bush carrier 12. A first whirling-turning-milling unit 8 is arranged on slide 5 (position 3.1) and the associated first guide bush carrier 12 is arranged on slide 5 (position 3.2). A second whirling-turning-milling unit 8 is arranged on slide 5 (position 4.1) and the associated second guide bush carrier 12 is arranged on slide 5 (position 4.2).

A workpiece 7 is clamped in each collet chuck 14 of the workpiece spindle 3. During machining in positions 3 and 4, the workpieces 7 are additionally held by the guide bush carriers 12.

FIG. 4 shows the whirling-turning-milling unit 8 and the guide bush carrier 12 during machining of a workpiece 7. The whirling-turning-milling unit 8 has a U-shaped housing 10, wherein a whirling unit 15 is arranged on a first leg 20 and a turning unit 17 and a milling unit 16 are arranged on the opposite second leg 21. The two legs 20, 21 are connected to one another by a web-like connecting body 22 and together form the U-shape.

FIG. 5 shows the whirling-turning-milling unit 8, which has a housing 10 comprising a first leg 20, a connecting body 22 and a second leg 21. The first leg 20 is located on the motor side 23. This means that, on the motor side 23, there is a drive for the rotary driven tools, e.g. for the whirling unit 15 and for the milling unit 16. The drive force is guided through the connecting body 22 via a transmission device and transmitted to the rotary driven tool 9 (milling unit 16) in the second leg 21, i.e. on the transmission side 24. The housing 10 of the whirling-turning-milling unit 8 thus serves not only as a holder for the individual tools 9, but also as a housing for a transmission device for the rotary driven tool 9 on the second leg 21.

FIG. 6 shows a bottom view of the whirling-turning-milling unit 8. The individual tools 9 are arranged on the two spaced legs 20, 21 without causing a collision. The whirling-turning-milling unit 8 has fastening devices on the underside in order to be attached to a tool carrier or a tool slide 5.

FIG. 7 shows a top view of the whirling-turning-milling unit 8. The housing 10 of the whirling-turning-milling unit 8 comprises the first leg 20, the connecting body 22 and the second leg 21. In the present embodiment, the first leg 20 forms the first component, while the second leg 21 and the connecting body 22 form a further component. However, the invention is not restricted to this. The housing 10 can, for example, be made in one piece or consist of several parts.

FIG. 8 shows a perspective view of the whirling-turning-milling unit 8. The whirling unit 8 is slightly rotated in relation to the housing 10. This is necessary if a thread with a specific pitch is to be whirled into the workpiece 7. On the motor side 23 there is a flange with which a connection is made to a drive for the rotating driven tools 9.

FIG. 9 shows the whirling-turning-milling unit 8 in a sectional view, wherein the transmission device is now visible.

On the motor side 23, there is an input shaft 28, which receives the power from a drive motor. Two toothed pinions 26 are arranged on the input shaft 28, wherein the force is transmitted to the whirling unit 15 via a first toothed belt 30 and the force is transmitted to a shaft 25 via a second toothed belt 27. The rotatable shaft 25 is arranged in the connecting body 22 and establishes a rotating connection between the motor side 23 and the gear side 24. On the gear side 24, there is another toothed pinion 26 on the shaft 25, which drives the milling unit 16 via a toothed belt 29.

FIG. 11 shows a perspective view of the guide bush carrier 12. The guide bush carrier 12 has a fastening part 34, with which the guide bush carrier 12 is fastened to a tool slide 7. Furthermore, the guide bush carrier 12 has a guide head 33, which is self-supporting and has a holder for the guide bush 13. The free-standing guide head 33 holds and/or guides the workpiece 7 during machining with the whirling-turning-milling unit 8 without the guide bush carrier 12 colliding with the whirling-turning-milling unit 8.

Furthermore, the guide head 33 has a shell-like recess 35 in the area of the holder for the guide bush 13 on the underside, which corresponds approximately to the shape of the workpiece spindle 3 or the collet chuck 14 of the workpiece spindle 3. The special shape of recess 35 makes it possible to move guide bush 13 relatively close to workpiece spindle 3 during machining of the workpiece without collision.

Furthermore, the guide bush carrier 12 has a lateral recess 36 in the area of the guide head 33, with which a collision is also avoided.

FIG. 11 shows a top view of the guide bush carrier 12. In the area of the guide head 33, the guide bush carrier 12 has numerous beveled or chamfered edges to avoid possible collisions with other components.

FIG. 12 shows a bottom view of the guide bush carrier 12, wherein the guide bush 13 is detachably arranged by means of a screw connection 37 on the guide head 33 of the guide bush carrier 12. The detachable screw connection 37 allows numerous different guide bushes 13 with different outlets to be inserted into the guide bushing carrier 12.

With the embodiment according to the invention, it is now possible to machine a long workpiece with a multi-spindle lathe without oscillations or vibrations occurring. This is achieved by using the whirling-turning-milling unit and the guide bush carrier, which are arranged on two adjacent tool slides.

### DRAWING CAPTION

1. Multi-spindle automatic lathe
2. Spindle drum
3. Workpiece spindle
4. Tool carrier
5. Tool slide
6. Synchronous spindle
7. Workpiece
8. Whirling-turning-milling unit
9. Tool
10. Housing
11 Slide pair
12. Guide bush carrier
13. Guide bush
14. Collet chuck from 3
15. Whirling unit
16. Milling unit
17. Turning unit
18. Spindle bearing
19. Spindle station
20. 1st leg
21. 2nd leg
22. Connecting body
23. Motor side
24. Gear side
25. Shaft
26. Pinion
27. Belt
28. Input shaft
29. Belt
30. Belt
31. Collision point
32. Bearing (hydrostatic)
34. Fastening part
35. Recess at 13
36. Recess (lateral)
37. Screw connection

1. A device for machining workpieces on a multi-spindle lathe, wherein the multi-spindle lathe comprises at least one tool carrier with a tool slide and at least two tool slides are associated with a rotatably mounted workpiece spindle of the multi-spindle lathe, wherein workpieces to be machined are arranged in the workpiece spindles, wherein at least one whirling-turning-milling unit is arranged on a first tool slide, which comprises a whirling unit a milling unit and a turning unit, and at least one guide bush carrier with at least one guide bush is arranged on the second tool slide, and wherein the guide bush carrier guides the workpiece during machining with the whirling-turning-milling unit.

2. The device according to claim 1, wherein the swivel-rotary milling unit comprises a housing on which the whirling unit, the milling unit and the turning unit are arranged.

3. The device according to claim 1, wherein a separate guide bush is detachably arranged on the guide bush carrier, wherein the guide bush is adapted to the diameter of the workpiece to be machined.

4. The device according to claim 1, wherein the whirling-turning-milling unit comprises a housing which is U-shaped and has two projecting, spaced-apart legs and in that a first tool is arranged on the first leg and a second and third tool are arranged on the second leg.

5. The device according to claim 1, wherein the whirling-turning-milling unit has a U-shaped housing with two spaced-apart legs, wherein the whirling unit is arranged on the first leg and the milling unit and the turning unit are arranged on the second leg.

6. The device according to claim 1, wherein the whirling-turning-milling unit has a housing with a motor side and a gear side spaced apart therefrom, wherein a transmission device is used to produce a power transmission to the gear side starting from the motor side.

7. The device according to claim 1, wherein the guide bush is acted upon by a coolant, whereby the workpiece is hydrostatically guided within the guide bush.

8. A tool carrier for a multi-spindle lathe, wherein the multi-spindle lathe comprises a machine frame on which a rotatably mounted spindle drum is arranged, wherein a plurality of rotatably mounted workpiece spindles are integrated in the spindle drum, in which workpieces can be accommodated, wherein the tool carrier comprises at least one tool slide which is associated with a rotatably mounted workpiece spindle of the multi-spindle lathe, wherein at least one whirling-turning-milling unit is arranged on a first tool slide and at least one guide bush carrier with at least one guide bush is arranged on the second tool slide, and in that the guide bush carrier guides the workpiece during machining with the whirling-turning-milling unit.

9. The tool carrier according to claim 8, wherein the swivel-rotary milling unit comprises a housing on which a whirling unit, a milling unit and a turning unit are arranged.

10. A multi-spindle lathe comprising a machine frame on which a rotatably mounted spindle drum is arranged, wherein a plurality of rotatably mounted workpiece spindles are integrated in the spindle drum, in which workpieces can be received, wherein the workpiece spindles are designed as spindle stations and each spindle station is assigned at least two tool slides which are arranged stationary on the machine frame and are designed as holders for at least one tool, wherein at least one whirling-turning-milling unit is arranged on a first tool slide and at least one guide bush carrier with at least one guide bush is arranged on the second tool slide and that the guide bush carrier guides the workpiece during machining with the whirling-turning-milling unit.

11. The multi-spindle lathe according to claim 10, wherein the whirling-turning-milling unit comprises a housing on which a whirling unit, a milling unit and a turning unit are arranged.

12. A method for machining at least one workpiece with a multi-spindle lathe which has at least one tool spindle and at least two tool slides which are arranged in a V-shape opposite the tool spindle, wherein a whirling-turning-milling unit is arranged on one tool slide and a guide bush carrier is arranged on the other tool slide, wherein the following method steps are carried out:
arranging at least one workpiece in the workpiece spindle of the multi-spindle lathe;
positioning of the guide bush carrier relative to the workpiece, wherein a guide bush of the guide bush carrier is placed on the workpiece to be machined, so that the workpiece is guided between the tool spindle and the tool by the guide bush;
aligning of the whirling-turning-milling unit, which comprises a whirling unit, a milling unit and a turning unit, and subsequent machining of the workpiece with the whirling unit and/or milling unit and/or turning unit.

13. The method according to claim 12, wherein the following method steps are carried out to produce a screw:
arranging at least one workpiece the workpiece spindle of the multi-spindle lathe;
positioning of the guide bush carrier relative to the workpiece, wherein a guide bush of the guide bush carrier is placed on the workpiece to be machined, so that the workpiece is guided between the tool spindle and the tool by the guide bush;
aligning the whirling-turning-milling unit, wherein a milling unit is aligned relative to the workpiece in the X, Y and Z axes and subsequent machining of the workpiece with the milling unit;
aligning the whirling-turning-milling unit, wherein a whirling unit is aligned relative to the workpiece in the X, Y and Z axes and subsequent machining of the workpiece with the whirling unit.
aligning the whirling-turning-milling unit, wherein a turning unit is aligned relative to the workpiece in the X, Y and Z axes and subsequent machining of the workpiece with the turning unit.

14. The method according to claim 12, wherein the guide bush carrier is moved in parallel with the whirling-turning-milling unit during machining of the workpiece and guides the workpiece.

15. The tool carrier for a multi-spindle lathe according to claim 8, comprising a device for machining workpieces on a multi-spindle lathe, wherein the multi-spindle lathe comprises at least one tool carrier with a tool slide and at least two tool slides are associated with a rotatably mounted workpiece spindle of the multi-spindle lathe, wherein workpieces to be machined are arranged in the workpiece spindles, wherein at least one whirling-turning-milling unit is arranged on a first tool slide, which comprises a whirling unit, a milling unit and a turning unit, and at least one guide bush carrier with at least one guide bush is arranged on the second tool slide, and wherein the guide bush carrier guides the workpiece during machining with the whirling-turning-milling unit, wherein a separate guide bush is detachably arranged on the guide bush carrier, wherein the guide bush is adapted to the diameter of the workpiece to be machined.
